(19) United States
(12) Patent Application Publication
(10) Pub. No.: US 2006/0069671 A1
(43) Pub. Date: Mar. 30, 2006

(54) Methodology, system and computer readable medium for analyzing target web-based applications

(76) Inventors: James W. Conley, Herndon, VA (US); Eric B. Cole, Leesburg, VA (US)

Correspondence Address: MARTIN & HENSON, P.C., 9250 W 5TH AVENUE, SUITE 200, LAKEWOOD, CO, 80226, US

(21) Appl. No.: 10/955,009

(22) Filed: Sep. 29, 2004

(51) Int. Cl. G06F 17/30

(52) U.S. Cl. 707/3

(57) ABSTRACT

A computerized method, a computer-readable medium and a computerized test system are provided for analyzing target web-based applications, for example, to identify design characteristics of the application which render it susceptible to exploit. Hypertext links within the application are navigated to obtain a listing of associated web pages. Each web page may then be parsed to extract associated traffic data which matches any search items pertaining to sensitive data categories of interest. The extracted traffic data is stored within a storage location to identify a compilation of potentially exploitable design characteristics.

### BACKGROUND OF THE INVENTION

The present invention generally relates to security assessment of applications for computer systems. More particularly, the invention is directed to identifying vulnerabilities in web-based applications which could be exploited by an attacker and, thus, render the application particularly insecure.

Documents used on the World Wide Web (WWW), commonly referred to as Web documents or web pages, contain text, graphics, animations and videos as well as hypertext links. Hypertext links in web page permit users to jump from one page to another, whether the pages are stored on the same server or on globally dispersed ones. Web pages are accessed and read via a web browser. Currently, two of the most popular web browsers are Internet Explorer® and Netscape Navigator®.

Web pages are maintained on website computers which support the Web's HTTP protocol. When a web site is initially accessed, one generally links to a home page, which is an HTML document that serves as an index to the site's contents. The fundamental web format is a text document embedded with hypertext markup language (HTML) tags providing the formatting of the page as well as the hypertext links (URLs) to other pages. HTML coding uses common alphanumeric characters that can be typed with a text editor or word processor. Numerous web publishing programs such as Word®and FrontPage®, to name a few, provide a graphical interface for web page creation, and automatic generation of the HTML codes. Basic web pages can, thus, be created without having to learning a particular coding system. Moreover, many word processors and publishing programs also export their documents to HTML. These aspects have helped fuel the Web's growth.

A web-based application is one which is launched from a web browser, such as Internet Explorer®, and typically downloaded from the Web each time it is run. The advantage is that the application can be run from any computer, and the software is routinely upgraded and maintained by the hosting organization rather than each individual user. From a security standpoint, however, such applications can be inherently vulnerable. Wed-based applications are “stateless” in the sense that the server does not know where the end user came from or where the end user will go next. Thus, the web pages themselves need to carry all the state information that the application needs in order for it to flow properly. Three popular ways that state is maintained is through cookies, GET requests, and forms. A cookie is data stored by a web server which provides a way for the website to keep track of a user's patterns and preferences and, with the cooperation of the web browser, to store them on the user's own hard disk. Cookies are often transmitted with web pages, but the end user does not see them because its browser strips off the cookies before displaying the web page. While cookies were originally intended to maintain stateful information, oftentimes they contain sensitive information, such as user names and passwords, which may be retained to save the end user from re-typing the information while perusing the website.

Another manner in which stateful information can be maintained is through GET requests. GET requests occur when URL (address) links contain additional information in the link line in the form of an ID/value pair. Often the ID/value pairs are placed on a GET request to point the web page and transfer certain state information. The server then strips off this information and uses it to build a new web page for display, and can even put the state information on the links in the new web page.

State information can also be transmitted with forms. When a form, such as a button on a web page, is clicked, a URL is passed since each form has a URL associated with it. Here, state information is not necessarily put on the URL as with a GET request, but is passed back more or less in ASCII along with the URL so that it is part of the HTTP format. Since the server knows it is a form, it knows where to grab that additional information and populate variables.

It can be appreciated that, unless web-based applications are designed with security in mind, they can have attendant security vulnerabilities due to the manner in which information is handled within the cookies, GET line requests, and the forms, for example. Such information can be quite sensitive it relates to categories such as usernames, passwords, user IDs, social security numbers, credit card numbers, phone numbers, names and addresses, or the like. While it is desirable to design web-based applications which are capable of maintaining state in some capacity, thereby to make it more attractive and enhance the navigation experience for the end user, this should be weighed against the potentially exploitable security issues which necessarily flow from poor design. Accordingly, since transmitted pages can be intercepted by attackers in a variety of known manners, it is helpful to design web-based applications in a manner which does not unnecessarily transmit sensitive data behind the scenes, such as through a server's echo, or even overtly.

Developing exploits of such applications can be more of an art than a science. Attackers can spend countless hours mulling over the inputs and outputs of an application looking for patterns and processes which peak their interest, such as those that can lead to the revelation of sensitive information of the types above. Oftentimes, an attacker will launch the application and keep branching through the various links until something suspicious is found. The attacker then explores the point of interest in greater detail for a possible means of exploiting the application. This method of crawling through an application to find potentially exploitable design characteristics can prove quite fruitful since vulnerabilities can be found in virtually any web-based application. One such example is Microsoft IIS Web Server, a popular application which is well scrutinized by both developers and attackers, yet new vulnerabilities requiring patches are revealed regularly.

In order to effectively examine a web-based application, a tester should put it under the same level of scrutiny as would be anticipated for a would-be attacker. Unfortunately, the attacker community can typically muster more resources at a lower cost than is allocated to testing budgets, thus putting developers at a disadvantage. Some programs do, however, exist for examining applications at some level for possible vulnerabilities. Some of these are proxy based in the sense that they examine target applications at a convenient location where all traffic passes between the end user and the location(s) of the requested web pages. One such example is “AppScan”, available from Sanctum of Santa Clara, Calif. “AppScan” is an HTTP proxy which monitors passing network traffic searching for web vulnerabilities. Information obtained from the company's website indicates that it provides automated, web-based application security testing for use in a quality assurance staging environment. It's ‘SiteSmart’ technology presumably learns the unique behavior of each web application, and delivers attack variants to test and validate application specific and common web vulnerabilities. Presumably also, it tests for web services technologies such as Net.

“RFProxy”, currently available at the website www.wiretrip.net of, is another proxy based web assessment tool which monitors network traffic to help identify and exploit vulnerabilities in online applications. It does so by acting as an HTTP proxy to actively interact with the HTTP traffic (e.g. rewriting the HTML) to extend features of the user's normal browser so that it is better suited for security testing. To this end, and according to information available about the product: (1) hidden forms become visible and can be edited; (2) radio, checkbox, and select fields can have arbitrary values; (3) max-length limitations are removed; (4) java script value checking is removed; (5) arbitrary headers can be added, deleted, or modified; (6) cookies can be added, deleted, or modified; and (7) requests can be captured, modified, or replayed.

Still another proxy based approach is “Elza”, available from Beyond Security, Ltd. of Inverness, Ill. Elza is a scripting tool used to interact with web applications. The claimed goal of the Elza project is to create a family of tools for HTTP communication that allow easier penetration testing and faster building of custom user agents (web spiders, robots, crawlers, etc.) Elza has it own language for scripting HTTP communication sessions (attacks, penetration tests, etc.). Also available is the Elza Perl to supplement the Elza Perl language, as well as a proxy server for analyzing HTTP communications to ascertain application and server vulnerabilities and record HTTP sessions, which can then be exported as Elza scripts.

Also generally known is “WebInspect”, available from spiDYNAMICS of Atlanta Ga. This is a vulnerability scanner that crawls websites. Information obtained from the company's website indicates the program enables application and web services developers to automate the discovery of security vulnerabilities as they build applications, access detailed steps for remediation of those vulnerabilities and deliver secure code for final quality assurance testing. The enterprise edition of the product is designed for enterprise-wide deployment and can be used during various phases of the web application lifecycle such as development, quality assurance, production and audit. Presumably, a secure coding process establishes guidelines and variables, and automatically indicates whether an application functions properly and securely on its own in both a test environment and in the real world.

Also known is a project referred to as “HTTPush”. HTTPush is part of SourceForge, which is an open source software development website providing a centralized projects repository for open source developers to control and manage software development. According to information available on the website, HTTPush provides auditing of HTTP and HTTPS application/server security, and it supports on-the-fly request modification, automated decision making and vulnerability detection through the use of plugins and full reporting capabilities.

Finally, “eEye Retina CHAM”, available from eEye Digital Security of Aliso Viejo, Calif. is a vulnerability assessment scanner that can be used to methodically scan every machine on the network, including a variety of operating system platforms (e.g. Windows, Unix, Linux), networked devices (e.g. firewalls, routers, etc.), databases, and third-party or custom applications. After scanning, it delivers a report detailing detected vulnerabilities and suitable corrective actions and fixes. A database of known vulnerabilities is automatically downloaded at the beginning of every session. Capabilities are also provided for users to write their own customized audits. The artificial intelligence option (CHAM) can be used for additional testing and detection of previously unknown security issues within the network.

As can be appreciated from the above, various techniques exist for generally evaluating web-based applications for vulnerabilities. Some of these (e.g. AppScan, RFProxy, and Elza) are proxy based, while others (e.g. WebInspect), actively attack the application in an effort to get the application to reveal a vulnerability which manifests outside of its normal use. An example of an active attack, for example, might be to try a variety of different passwords on an application's login form to try to circumvent normal safeguards. While these past approaches may be desirable in certain contexts, there remains a need to provide security professionals with a more efficient means for passively examining the performance of web-based applications in order to assess the application's security from the standpoint of an end user under normal (i.e. typical) browsing conditions. The present invention is primarily directed to meeting this need.

### BRIEF SUMMARY OF THE INVENTION

The present invention provides a computerized method, a computer-readable medium and a computerized system for analyzing target web-based applications such that design characteristics can be identified which render the application potentially susceptible to exploit. According to one embodiment of the computerized method, HTML traffic associated with each of plurality of navigable web pages of the target application is examined to extract any matching traffic data which satisfies pre-established search criteria. Matching traffic data is then stored within a common data storage location thereby to identify the potentially exploitable design characteristics. In an alternative embodiment of the computerized method, a set of search items pertaining to sensitive data categories of interest is established. A web browser application is launched on a first network computer, and the target application is accessed via the web browser application. The target application being hosted by a second network computer. Hypertext links of the target application are navigated to in order to obtain a listing of associated web pages, each characterized by associated HTML traffic. Each respective web page within the listing is downloaded from the second network computer, and its HTML traffic is parsed to extract traffic data which matches any of the search items. Matching traffic data is then stored within a sensitive data storage location, thereby identifying the compilation of design characteristics which are potentially exploitable. A computer-readable medium and a computerized test system are also provided for analyzing a target web-based application. The computer-readable medium has executable instructions for performing a methodology similar to that above, while the computerized test system comprises a storage device, a processor programmed to perform such a methodology, and an output device for displaying the compilation of design characteristics.

Other advantageous features can be recognized in the various embodiments of the present invention. For example, it is preferred that the sensitive data categories of interest be selected from a group of categories such as user names, passwords, user IDs, social security numbers, credit numbers, phone numbers, names and addresses. The search items themselves may be a plurality of keywords each corresponding to one of these sensitive data categories. The HTML traffic can be considered to include an associated HTML header and associated HTML code. In preferred embodiments at least the code, but perhaps also the HTML header, are searched to ascertain an existence of any keyword(s) therein. Advantageously also, the HTML header can be parsed to extract both cookie data and session data, if present. In addition, image data can be extracted from the HTML traffic. Each of these extracted data types may be stored in respective storage locations. Advantageously also, navigation of the hypertext links within the target application may be accomplished either manually or automatically. In either case, navigation of the links will occur according to a navigation sequence which may be stored thereby to create a mapping of the target application.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 illustrates a diagram of an exemplary general purpose network computer system that may be configured to implement aspects of the present invention;

FIG. 2 diagrammatically illustrates an operating environment in which illustrative embodiment(s) of the present invention can be implemented;

FIG. 3 represents a high level flow diagram for computer software which implements the functions, for example, of the computerized test system of the present invention;

FIG. 4 is a more detailed flowchart showing the process control and data flow for computer software which implements the functions of the computerized test system;

FIG. 5, for representative purposes, shows an output window which could generated upon initial inspection of a web page according to the invention;

FIG. 6(a) illustrates a representative home page for a target application to be analyzed;

FIG. 6(b) shows the HTML code listing for generating the representative home page of FIG. 6(a);

FIG. 6(c) shows a representative output sub-window generated upon initial inspection of the home page of FIG. 6(a) according to the aspects of the present invention;

FIG. 7(a) illustrates another web-page for the target application which can be accessed from the home page of FIG. 6(a);

FIG. 7(b) shows the HTML code listing for generating the representative home page of FIG. 7(a); and FIG. 7(c) shows another representative output sub-window generated upon inspection of the web-page of FIG. 7(a) according to the aspects of the present invention.

### DETAILED DESCRIPTION OF THE INVENTION

The present invention is directed to efficiently identifying exploitable vulnerabilities in web-based applications so that security professionals are better equipped to make security assessments. In one of its various embodiments, the invention provides apparatus in the form of a computerized test system for assisting a tester or a security analyst in identifying potential vulnerabilities in web-based applications. Methodologies and a computer-readable medium embodying these capabilities are also provided. The test system of the invention includes both hardware and software architecture. For explanation purposes only, the software side of the system's architecture is referred to as a web application test platform, or WATP. The WATP will allow an analyst to identify potential security issues in a web-based application, referred to as a “target application” during the normal use, while also facilitating the analyst's attempt to ascertain additional vulnerabilities associated the target application. Inputs and outputs of the target application are examined in a manner similar to how a would-be attacker might do so. For purposes of the description, an attacker is considered to be one who desires to exploit potential vulnerabilities in the target application which stem from it's design. The attacker might do so, for example intercepting web traffic through known means and gathering sensitive data that is transmitted within the traffic. Inputs and outputs, respectively, refer to the application layer traffic to and from the target application. Suitable findings generated by the invention can then be presented to the tester or security analyst, referred to simply as the “analyst”, for further investigation. Advantageously, testing efficiencies may be provided through the use of navigation and replay support. This will allow the analyst to concentrate on one area of the application quickly and repeatedly without the need to manually re-establish the initial conditions.

In its exemplary embodiment, the WATP does not rely on known third party web browsers, such as Internet Explorer® or Netscape Navigator®. Instead, the invention contemplates the development of a custom web browser application which itself is designed to provide all the browsing capabilities that are needed to evaluate a target application. Using a custom web-browser, the analyst interfaces to the web-based application to be tested as is common with any type of browser. Unlike a traditional web browser, however, the WATP's browser captures (i.e. records) the inputs and outputs of the application for later recall, replay, and examination. It also searches for sensitive data, much like a would-be attacker would do manually. Development of a custom web browser, in this sense, simply means that a suitable web browser application needs to be developed since current third party web browsers do not come equipped with the capabilities discussed herein. Fortunately, there are many tools available in the marketplace for developing a web browser to accommodate such capabilities. For example, the Microsoft® architecture comes equipped with various Microsoft® component utilities, and these utilities can be combined in such a manner to produce a web browser that can have access to passing HTML code, and enhanced through Visual Basic (VB) scripting, as desired. Open source code for browsers is also readily available which can be tailored and adapted to accomplish the aspects of the invention. Accordingly, once a suitable browser has been developed, it can operate in conjunction with suitable parsing routines, such as accomplished with Perl scripting or the like to analyze the various web pages of with the target application according to the teachings herein.

Current application testing is predominantly conducted manually and can be quite laborious, requiring the analyst to methodically scrutinize the application's inputs and outputs in the hope of identifying vulnerabilities. Even then, there is no assurance that the analyst has investigated all possible branches of the application. According to the invention, provisions are made for automated testing of the target application to support the analyst in identifying vulnerabilities more efficiently and more thoroughly. Various types of security vulnerabilities could be detected according the aspects of the invention. For example, because it will see the same traffic as a man-in-the-middle (MiM), the WATP can test for potential MiM attacks. In this way, if sensitive information or practices are used by the application, then WATP could be configured to identify the MiM threat. This is advantageous since a MiM attack could lead to hijacking or replay. Hijacking occurs when an attacker takes over a user's session and makes transactions unknown to the user. Replay occurs when the attacker captures a transaction and retransmits the data causing the transaction to occur multiple times. The WATP will be able to detect the use of sensitive items in the traffic to and from the application, such as credit card and social security numbers, as well the use of privacy data in the traffic to and from the application. Such privacy data may consist of names, addresses, passwords, account numbers and similar items. The WATP will also be able to detect the transmission of other types of potentially exploitable data, such names, phone numbers, and other information in comment fields, that could be used as part of a social engineering attack on an application.

The WATP has an automatic mapping mode, which will ‘walk’ through the entire application following all links. In such a manner, the WATP will map out the navigation of the web-based application, thereby allowing the security analyst to verify that all parts of the target application have been investigated. Advantageously also, is an option to record a session. The recorded session can then be replayed at a later time if desired. Reconstruction of the original session, or replay, is accomplished by following the same links and providing the same inputs as when the session was first recorded. This will allow the security analyst to quickly and consistently return to the same place in the application. In this way, the analyst can focus on one particular part of the target application. If desired, provisions can also be made to stop at critical times during replay to alert the analyst of discovered vulnerabilities.

Capabilities of the present invention can be extended through the use of Visual Basic (VB) scripts, for example, or other suitable programming syntax. That is, it is contemplated that the analyst can write and use VB scripts to do specific analysis on portions of the target application which have been identified as exploitable areas (i.e. vulnerable). An example of how a VB script might be used is in conducting a brute force attack against a login portion of the target application. Another example might entail the use of a VB script to ensure that certain information intended by a designer appears on every web page, such as in headers or footers. The VB scripts would probably be written outside of the WATP application but called on demand.

In the following detailed description, reference is made to the accompanying drawings which form a part hereof, and in which is shown by way of illustrations specific embodiments for practicing the invention. Identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

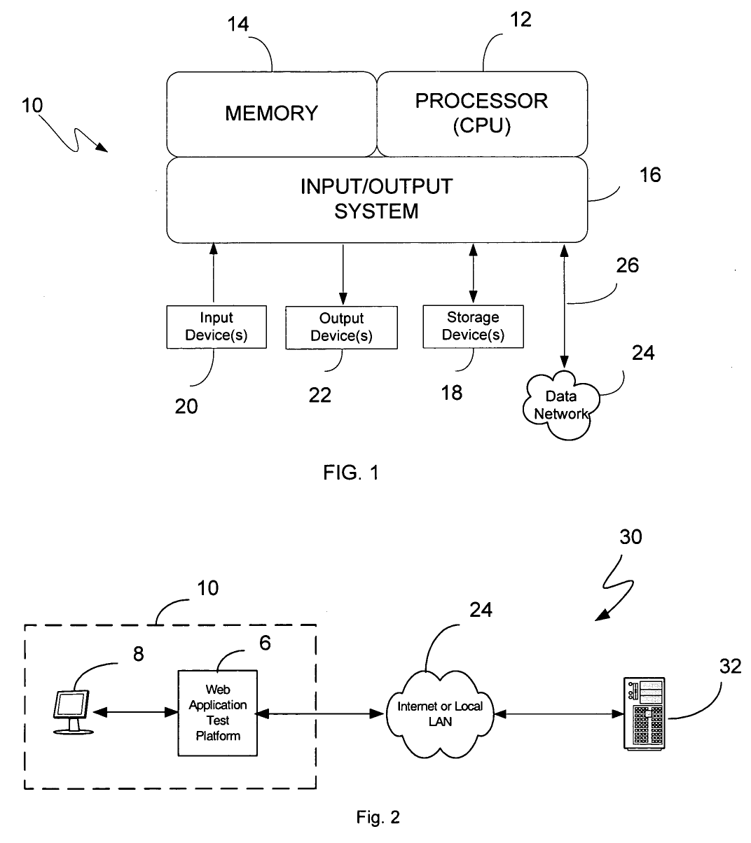

Aspects of the present invention may be implemented on an end user's host computer system 10, such as shown in FIG. 1. More particularly, computer system 10 may be used to execute programs for testing web-based applications, thereby comprising computerized test systems constructed in accordance with the present invention. Computer system 10 may be adapted to execute in any of the well-known operating system environments, such as MS-DOS, PC-DOS, OS2, UNIX, MAC-OS and WINDOWS, or other operating systems.

Computer system 10 comprises a central processing unit (CPU) 12, a memory 14 and an I/O system 16. The memory may include volatile memory such as static or dynamic RAM and non-volatile memory such as ROMs, PROMs, EPROMs. Various types of storage devices 18 can be provided as more permanent storage areas. Such devices may be a permanent storage device such as a large-capacity hard disk drive, or a removable storage device such as a floppy disk drive, a CD-ROM drive, a DVD-ROM drive, flash memory, a magnetic tape medium, or the like. Remote storage over a network is also contemplated. One or more of the memory or storage regions may contain programming code capable of configuring the computer system 10 to embody aspects of the present invention. The present invention, thus, encompasses program storage on an appropriate computer-readable medium, such as RAM, ROM, a disk drive, or the like and which is executable by processor 12, thereby to form an exemplary computerized test system for analyzing web-based applications. The I/O system 16 may operate with various input and output devices, 20 & 22 respectively, such as a keyboard, a display, OR a pointing device. It also operates with a data network 24 via a suitable communications link 26, as well understood in the art.

Although certain aspects of a computer system may be preferred in the illustrative embodiments, the present invention should not be unduly limited as to the type of computer on which it runs, and it should be readily understood that the present invention indeed contemplates use in conjunction with any appropriate information processing device, such as a general-purpose PC, a PDA, network device or the like, which has the capability of being configured in a manner for accommodating the invention. Moreover, it should be recognized that the invention could be adapted for use on computers other than general purpose computers, as well as on general purpose computers without conventional operating systems.

Source code for the WATP software could be developed using a variety of widely available programming languages with the software component(s) coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

Software embodying the present invention may be distributed in known manners, such as on a computer-readable medium which contains the executable instructions for performing the methodologies discussed herein. Alternatively, the software may be distributed over an appropriate communications interface so that it can be installed on the user's computer system. Furthermore, alternate embodiments which implement the invention in hardware, firmware or a combination of both hardware and firmware, as well as distributing the modules and/or the data in a different fashion will be apparent to those skilled in the art. It should, thus, be understood that the description to follow is intended to be illustrative and not restrictive, and that many other embodiments will be apparent to those of skill in the art upon reviewing the description.

With the above in mind, an operating environment 30 for implementing aspects of the present invention is shown in FIG. 2. The WATP software (i.e. the custom browser application) 6 is run remotely on a suitable hardware platform 8, thereby to form computer system 10 having capabilities such as discussed above. Computer system 10 may be the same as the end user of the target application. Accordingly, this can be referred to as either the end user's host computer system 10, or more generally as a first network computer. In a preferred implementation, the user will launch the WATP, which will provide a web-based interface in which to run the target application that is to be analyzed, as well understood in the art. More particularly, when the application is launched the user typically enters the URL for the web-based target application. A connection is then made, which may be via the Internet or a local LAN 24, to a remote server 32 hosting the target application. This remote server 32 can be referred to as a second network computer. From the remote server's perspective, the WATP is the “user” of the target application, and no additional privileges or access would be required. The WATP will analyze various aspect of web traffic including the inputs (to server 32) and outputs (from server 32) for exposure of sensitive or critical data. It preferably checks for: (1) the use of common private data such as names, address, and phone numbers; (2) the use of specific sensitive data such as financial or medical data, social security numbers, credit card numbers; (3) and the potential disclosure or other types of information which are often helpful to attackers such as file names, directory listings, usernames, passwords, user IDs, etc. These are merely representative of the types of sensitive data categories which might be desirable to search.

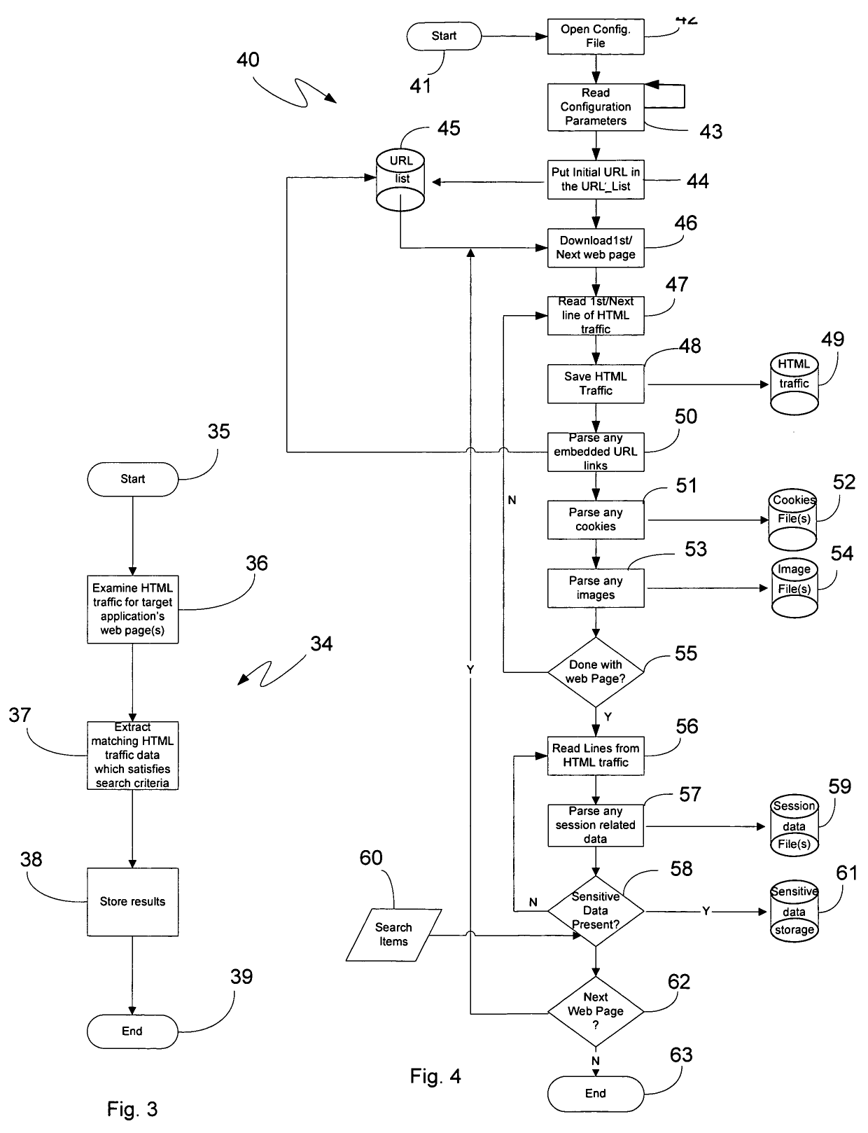

A high level flow diagram 34 for computer software which implements, for example, the functions of the computerized test system of the present invention may now be appreciated with reference to FIG. 3. Following start 35, HTML traffic for the target application's web page(s) is examined at 36, and HTML traffic data is extracted at 37 which satisfies pre-determined search criteria. For example, in preferred embodiments, it is desirable to search the HTML traffic for various keywords corresponding to sensitive data categories. Results are stored at 38, and high level flow diagram 34 ends at 39.

A more detailed version of this methodology may now be appreciated with reference to flow diagram 40 shown in FIG. 4. Following start 41, a configuration file is opened at 42 and the various configuration parameters therein are recursively read at 43. Various configuration parameters are contemplated by the present invention. The ordinarily skilled artisan will appreciate that these parameters can be maintained in a configuration file with programming code suitably tailored to accommodate such capabilities. Various modes and actions are contemplated to provide features which may be selected by the user. For example, and as discussed above, functionalities of conventional web browsers is provided so that the user can manually navigate the target application. Alternatively, capabilities can be implemented so that the various links within the web pages are followed automatically so that a significant amount of the target application can be mapped out relatively quickly. This will save the security analyst from having to manually access all forms, etc. within the target application. In either case though, all web pages which are visited while browsing the target application can be mapped out, it being understood that such mapping may incorporate the various links and forms which are parsed in the HTML returned by the application. By using such automated navigation and mapping which can be readily realized via suitable programming routines, the security analyst can ensure that every link or form has been exercised or tested. This is an important feature if the analyst is to test the entire web-based target application.

Recordings can be made of the entire user input and web-based application responses during browsing. This recorded information can be used to recall and replay the session, as desired. To this end, a session may constitute full testing of the target application or merely a portion thereof. Thus, a previously recorded session can be replayed at a user's desire at anytime, and stops or “bookmarks” can be saved and loaded as well to provide a variety of navigation capabilities to the analyst.

Once the configuration parameters are read at 43, methodology 40 proceeds at 44 to place the initial URL of the target application into a URL list 45. Typically, this initial URL will correspond to the homepage of the target application and identified as “index.html”. At the first pass, the web page corresponding to this first URL is downloaded at 46 and the first line of its HTML traffic is read at 47. For purposes of the invention, the term “HTML traffic” is deemed to encompass both the HTML header as well as the HTML code (or body) for an associated web page. In preferred embodiments, it is desirable to parse through all of the HTML traffic, although it is certainly contemplated that only selected portions thereof could be parsed based on one's preferences.

Once the first line of the traffic is read at 47 it is saved at 48 into an HTML traffic storage location 49, which may be a selected file corresponding to the particular web page encountered. At 50, the given line of HTML traffic is parsed to identify an existence of any other URL links therein. If any are found, they are appended to the URL list 45 to update it accordingly. Any cookies associated with the respective web page are then parsed at 51, it being understood that the cookies would typically be present within the HTML header. If any associated cookie data is found within the subject HTML line at 51, it is preferably placed into an associated cookie file 52. Similarly, the web traffic may be parsed at 53 to locate any images (jpg, gif, etc.) which can then be stored in suitable image files 54.

If parsing of the web page is not complete at 55 (i.e. there are additional lines to be read) the program flow returns to function 47 to read the next line of the HTML traffic. Once all lines have been read and according parsed, the response to inquiry 55 is in the affirmative and program flow 40 preferably now proceeds at 56 to recursively read lines of the HTML traffic to parse any session related data at 57 and determine an existence of any sensitive data at 58. It may be recalled that state information is sometimes transmitted within GET requests so that it can be located at 57. If any session data is located it may be stored in an appropriate session data file at 59.

Recursively, for each lines of the HTML traffic, determinations are made at 58 as to whether any sensitive data is present. These determinations are preferably made by ascertaining if any of the HTML traffic matches search items 60, which may be a plurality of keywords each pertaining to a particular sensitive data category of interest, as discussed herein. Any matching HTML traffic data is then preferably placed into a common sensitive data storage location 61. Of course, the ordinarily skilled artisan will appreciate that the various search items 60 which are contemplated may be any of a variety of keywords or other search criteria of interest which can be accommodated by programming capabilities when examining the HTML traffic. In any event, once all lines of the HTML have been searched, program flow 40 proceeds to determine at 62 whether there are any other web pages to be examined. Thus, if there are any additional links which were found and appended within the URL list 45, the web page associated with the next such link would then be downloaded at 46 and suitable processes above repeated until there are no more web pages in response to the inquiry at 62. At that point, methodology 40 ends at 63.

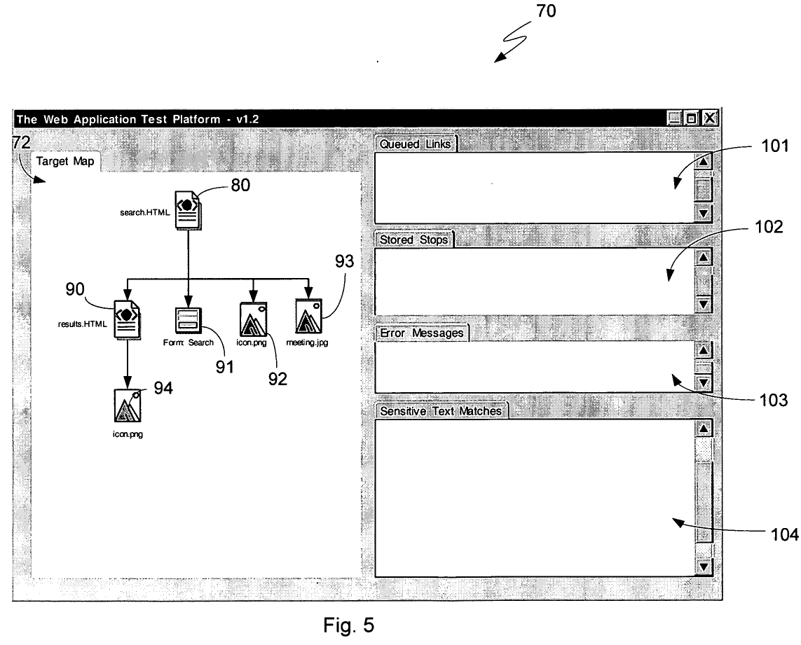

When a target application is parsed, such as in accordance with the flow diagram of FIG. 4, a first output window 70 may be presented to the user as representatively depicted in FIG. 5. As each page of the target application is read and parsed, the images, scripts, links, and forms referenced in the HTML code may be mapped as a two-dimensional tree representation 72, identified in FIG. 5 by the tab “Target Map”. For purposes of the invention, the various information associated with a given web page (i.e. the HTML code, images, cookies, etc.) may be deemed to be defined at that time at which the user's browser no longer issues requests to the server, and the server no longer fulfills requests. Since the home page for the web-based application is read first, the display of FIG. 5 will tend to be hierarchical.

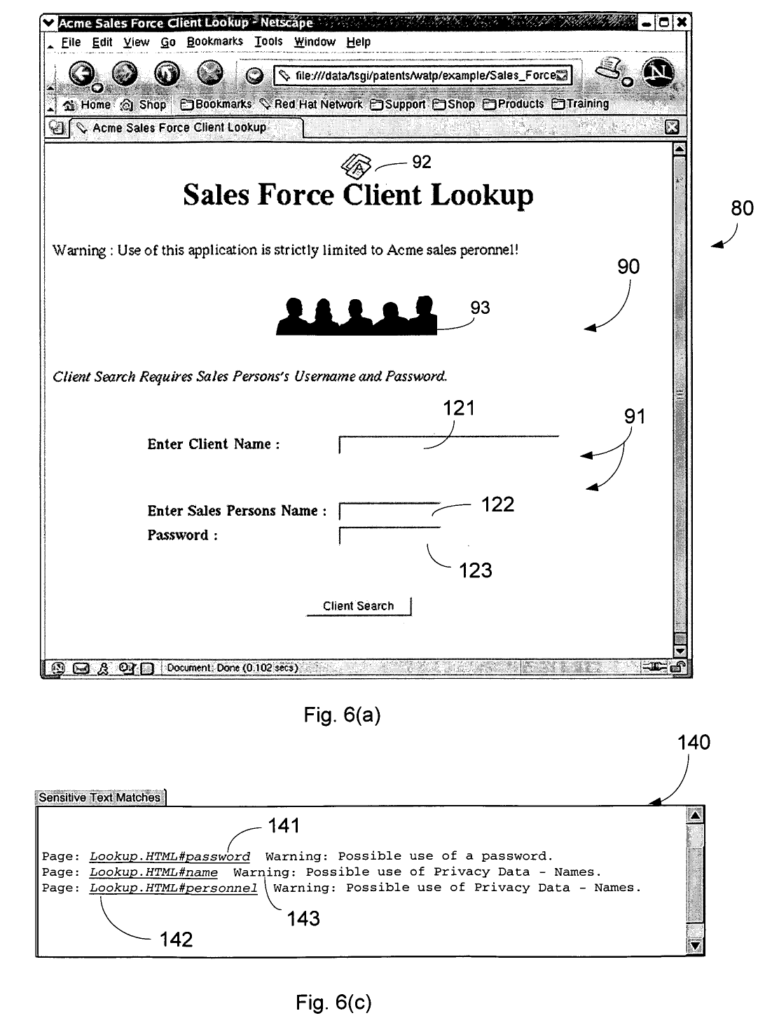

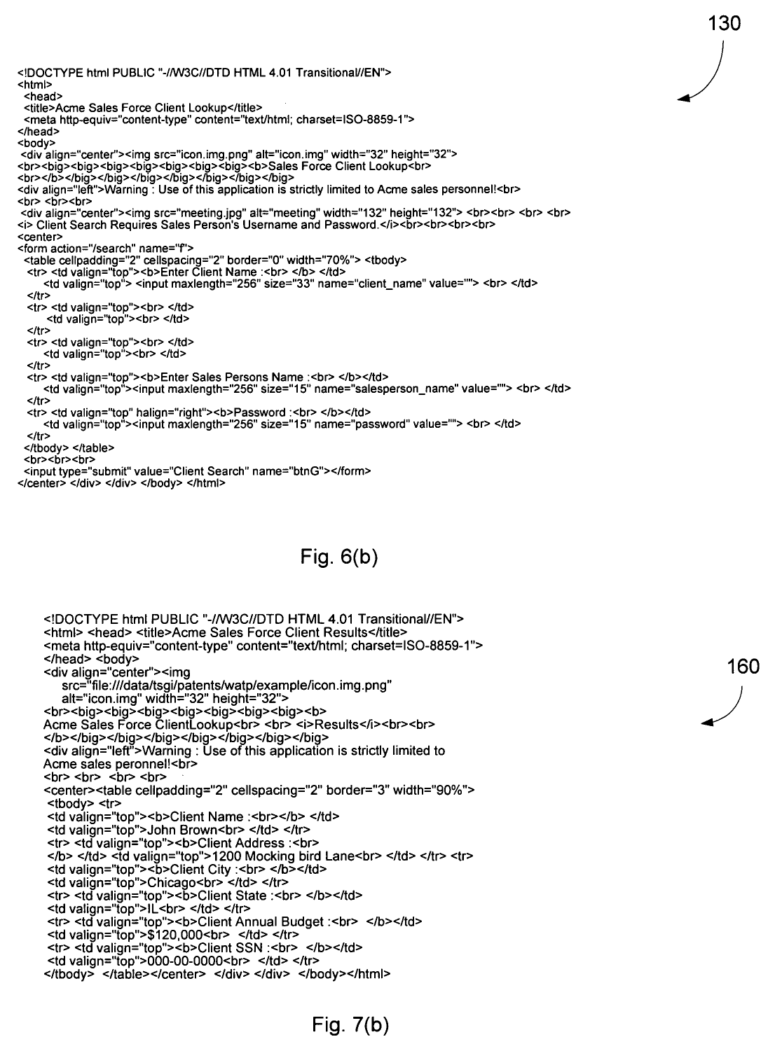

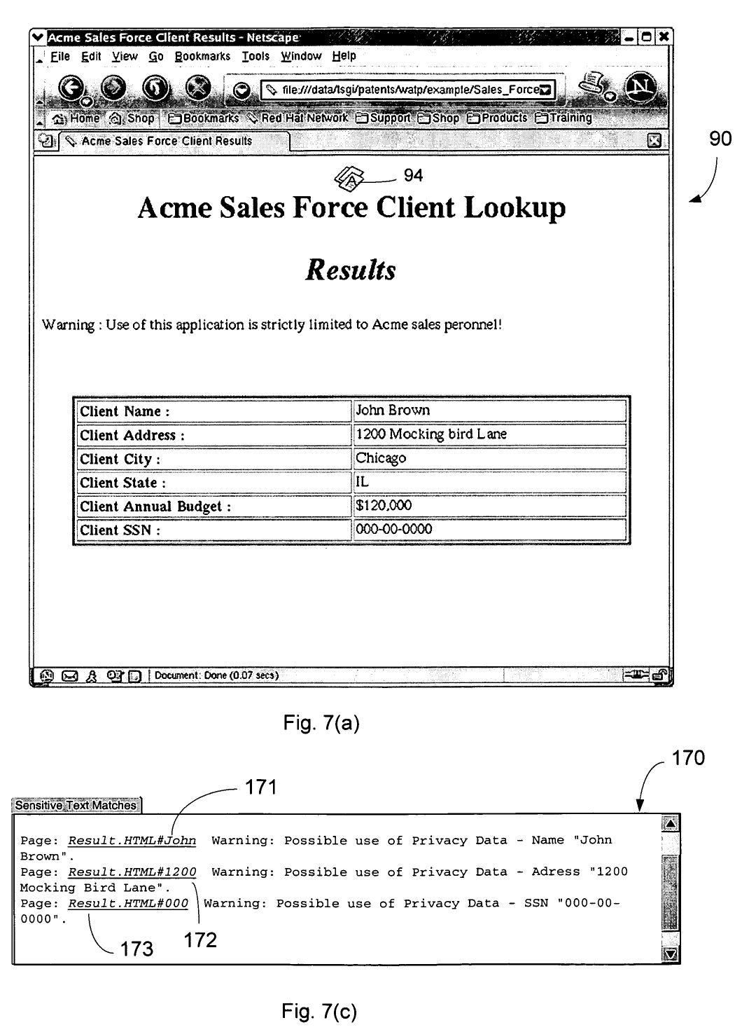

However, it should be appreciated that FIG. 5 only represents a portion of the web-site's overall tree representation, namely, that pertaining to a representative search page (“search. HTML”) 80, as visually represented in FIG. 6(a), and a results page (“results.HTML”) 90 as visually represented in FIG. 7(a). Other pages which might be associated with the target application, such as its index.HTML, etc. are not shown in the snapshot view of FIG. 5, but could be navigated to via conventional techniques.

It may be appreciated with reference to FIGS. 5, 6(a) and 7(a) that tree 72 incorporates icons for the various data types which have been recognized as the WATP parses search page 80 and results page 90. For example, with respect to HTML page 80, the WATP has recognized information pertaining to results.HTML 90, images (png, jpg) 92, 93 and the page's form 91 which encompasses search fields 121-123. As for results page 90, the WATP has identified the image icon 94. The remaining information visually shown in FIG. 7(a) is deemed encompassed by the icon “results.HTML” 90 in FIG. 5.

Also shown as part of representative output window 70 are a plurality of list boxes 101-104. List box 101, identified in FIG. 5 as “Queued Links”, can be selectively populated with any icon (image, script, link or form) from target map 72, such as by the user right clicking on the associated icon(s) and selecting a copy option from a pop-up menu. It is contemplated, then, that the security analyst can later click on any icon on the list box 101 to quickly investigate in greater detail that part of the target application. In a similar manner, another list box 102 can be selectively populated with icons whereby the user designates as “stops” certain web pages, such as those corresponding to icons 80 and 90 in the target map 72. These can then provide bookmark locations which can be conveniently accessed when replaying one's navigation of the target application. Implementing such capabilities would be well within the purview of the ordinarily skilled artisan such that further details for accomplishing the same need not be provided.

A third list box 103 in FIG. 5 provides a convenient location for the WATP to alert the user by way of error messages of any difficulties encountered while performing any requested operations during analysis of the target application. It is contemplated, here, that the user can then click on a selected error message(s), whereupon the web page which cased the error will be recalled.

Finally, a fourth list box 104 identified as “Sensitive Text Matches” is where the WATP can store links corresponding to questionable or sensitive data encountered while parsing associated HTML traffic for the web-page(s). It is contemplated, then, that the security analyst can then click on the associated link in list box 104 to cause the browser to recall the web page containing the identified text, so that the analyst can further investigate the nature of the sensitive data.

With an appreciation of the above, the remaining figures to provide a more detailed look at how the WATP of the present invention can be implemented to find potential security risks associated with a simple web-based application. Initial reference is again made to search page 80 that is visually depicted in FIG. 6(a). Here, the selected web page 80 corresponds to a sales force lookup page for an “Acme” application. It is from this lookup page 80 that information about various clients can theoretically be obtained. Listing 130 in FIG. 6(b) shows the HTML code for generating the web application's search page 80 in FIG. 6(a). Upon examining the HTML code listing 130 for possible security and privacy risks, certain keywords will likely be flagged and brought to the attention of the security professional. These might include, for example the words “password”, “name”, and “personnel”. This information will be populated into the “Sensitive Text Matches” list box 140 as shown in FIG. 6(c). Within list box 140, three links 141-143 are thus provided so that the analyst can conveniently navigate to the appropriate page 80 at a later time to further evaluate these detected design characteristics.

Then, and with reference again to FIG. 6(a), normal operation of the target application would entail the entry by a user (the analyst here) of pertinent text within the fields 121-123 in order to search a particular client. Upon doing so, a resultant web page, such as in the results page 90 of FIG. 7(a) might be presented, and its corresponding HTML code listing 160 is shown in FIG. 7(b). Examination of HTML code listing 160 will likely flag other search items, such as the text matches identified in the links 171-173 within list box 170 of FIG. 7(c). This information, particularly that of the social security number identified in link 173, would be flagged as sensitive to warn the analyst about it.

From the above, it may appreciated that the present invention provides a useful tool for an analyst to examine a target web-based application to assess and identify potentially exploitable vulnerabilities in its design from a security standpoint. With such an investigative tool, the analyst can then, if desired, put into motion remedial measures aimed at alleviating the potential security issues. Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A computerized method for analyzing a target web-based application to identify design characteristics which render the target application susceptible to exploit, said computerized method comprising:
a. establishing a set of search items pertaining to sensitive data categories of interest;
b. launching a web browser application on a first network computer;
c. accessing the target application via said web browser application, whereby the target application is hosted by a second network computer;
d. navigating through hypertext links within the target application to obtain a listing of web pages associated with the target application, each web page being characterized by associated HTML traffic; and
e. sequentially, for each respective web page within said listing:
(i) downloading the respective web page from the second network computer;
(ii) parsing the respective web page's HTML traffic to extract traffic data which matches any of said search items; and
(iii) storing said traffic data within a sensitive data storage location, thereby to identify a compilation of said design characteristics.

2. A computerized method according to claim 1 whereby the sensitive data categories of interest are selected from a group of data categories consisting of: usernames, passwords, user IDs, social security numbers, credit card numbers, phone numbers, names and addresses.

3. A computerized method according to claim 2 whereby said search items include a plurality of keywords each corresponding to a respective one of said sensitive data categories.

4. A computerized method according to claim 1 whereby said search items include a plurality of keywords.

5. A computerized method according to claim 4 whereby said HTML traffic includes an associated HTML header and associated HTML code, and whereby each associated HTML code is parsed to ascertain an existence of any of said keywords therein.

6. A computerized method according to claim 5 comprising parsing each associated HTML header to extract cookie data corresponding to each cookie present therein.

7. A computerized method according to claim 1 comprising parsing said HTML traffic to extract any session data therein that is used to maintain state.

8. A computerized method according to claim 1 whereby said HTML traffic includes an associated HTML header and associated HTML code, and whereby parsing of the HTML traffic is accomplished by sequentially analyzing each line within both the HTML header and the HTML code to ascertain presence of any of the search items therein.

9. A computerized method according to claim 1 comprising extracting image data corresponding to each image file that is present within said HTML traffic and storing said image data within an image data storage location.

10. A computerized method according to claim 1 comprising extracting cookie data corresponding to each cookie that is present within said HTML traffic and storing said cookie data within a cookie data storage location.

11. A computerized method according to claim 1 comprising automatically navigating to all hypertext links associated with the target application and storing URL data corresponding to each hypertext link within a URL storage location.

12. A computerized method according to claim 1 comprising manually navigating through hypertext links within the target application.

13. A computerized method according to claim 1 comprising storing navigation of the hypertext links as a navigation sequence whereby to create a mapping of the target application.

14. A computerized method for analyzing a target web-based application for potentially exploitable design characteristics, said computerized method comprising:
a. examining HTML traffic that is respectively associated with each of a plurality of navigable web pages of the target application;
b. extracting from said HTML traffic any matching traffic data which satisfies pre-established search criteria; and
c. storing said matching traffic data within a common data storage location thereby to identify the potentially exploitable design characteristics.

15. A computerized method according to claim 14 whereby satisfaction of the pre-established search criteria occurs if any of a plurality of keywords is present in the HTML traffic.

16. A computerized method according to claim 15 whereby each of said keywords pertains to a sensitive data category that is selected from a group of data categories consisting of: usernames, passwords, user IDs, social security numbers, credit card numbers, phone numbers, names and addresses.

17. A computerized method according to claim whereby said HTML traffic includes an associated HTML header and associated HTML code, and whereby examination of the HTML traffic is accomplished by sequentially analyzing each line within both the HTML header and the HTML code to assess satisfaction of the pre-established search criteria.

18. A computer-readable medium having executable instructions for performing a method comprising:
a. launching a web browser application on a first network computer;
b. accessing a target application hosted by a second network computer via said web browser application;
c. navigating through hypertext links within the target application to obtain a listing of web pages associated with the target application, each web page being characterized by associated HTML traffic; and
d. sequentially, for each respective web page within said listing:
(i) downloading the respective web page from the second network computer;
(ii) parsing the respective web page's HTML traffic to extract traffic data which matches any of a plurality of pre-established search items; and
(iii) storing said traffic data within a data storage location, thereby to identify a compilation of said design characteristics.

19. A computer-readable medium according to claim 18 wherein said method comprises parsing said HTML traffic to extract cookie data corresponding to each cookie present therein.

20. A computer-readable medium according to claim 18 wherein said method comprises parsing said HTML traffic to extract any session data therein that is used to maintain state.

21. A computer-readable medium according to claim 18 wherein said HTML traffic includes an associated HTML header and associated HTML code, and whereby parsing of the HTML traffic is accomplished by sequentially analyzing each line within both the HTML header and the HTML code to ascertain presence of any of the search items therein.

22. A computer-readable medium according to claim 18 wherein said method comprises automatically navigating to all hypertext links associated with the target application, and storing a navigation sequence whereby to create a mapping of the target application.

23. A computerized test system for analyzing a target web-based application, comprising:
a. a storage device;
b. a processor programmed to:
i. launch a web browser application on a first network computer;
ii. access a target application hosted by a second network via said web browser application;
iii. navigate through hypertext links within the target application to obtain a listing of web pages associated with the target application, each web page being characterized by associated HTML traffic; and
iv. sequentially, for each respective web page within said listing:
(a) download the respective web page from the second network computer;
(b) parse the respective web page's HTML traffic to extract traffic data which matches any of a plurality of keyword search items; and
(c) store said traffic data within a sensitive data storage location, thereby to identify a compilation of said design characteristics; and
c. an output device for displaying said compilation of design characteristics.
